(19) United States
(12) Patent Application Publication
(10) Pub. No.: US 2002/0065895 A1
(43) Pub. Date: May 30, 2002

(54) Method for transferring electronic mail

(75) Inventors: Ming Zhang, Beijing (CN); Wenmin Qi, Beijing (CN)

Correspondence Address: WILLIAM COLLARD, COLLARD & ROE, P.C., 1077 NORTHERN BOULEVARD, ROSLYN, NY, 11576, US

(73) Assignee: Peking University Teclick Cyberworks Co., Ltd.

(21) Appl. No.: 09/816,025

(22) Filed: Mar. 23, 2001

(30) Foreign Application Priority Data
Oct. 18, 2000 (CN) 00129922.0

(51) Int. Cl. G06F 15/16

(52) U.S. Cl. 709/206

(57) ABSTRACT

The present invention relates to a method of email transmission. In the method, the packaging of transmission data, the setting of access permission of recipient to each sent mail by sender or registered server, and the delivering of title message to recipient, enable a recipient to get a message directly, as appropriate, from sender's storage area, eliminate forwardness between or among servers, hence, avoid the redundant storage of an identical email in network and an email box stacked with maliciously sent mails, improve the efficiency of email transmission and storage, save resources of the entire network, and ensure the security and efficiency of email transmission.

This invention generally relates to a method for transferring data in computer networks. In particular, it relates to a method for transferring electronic mails.

### BACKGROUND OF THE INVENTION

In computer networks, both LANs and the Internet, electronic mail, or email is widely used. The transfer of email is a significant part of data transmissions by the networks. A method for transferring emails usually comprises sending and receiving procedures. Now, sending email is generally based on SMTP (Simple Mail Transfer Protocol). SMTP-based email sending commonly comprises following steps: First, the email data delivered by a sender are encoded, and then sent to the server which is designated by the sender through SMTP. Upon receiving the email, the server then forwards it to another server (possibly the same) designated by the email address. The forwarding will be tried till it succeeds or exceeds certain predetermined times N, in the latter case the sender receives an error report.

Receiving email is generally based on POP (Post Office Protocol), which comprises the following steps:

A receiver downloads emails from its registered mail server and decodes the mail data.

By analyzing above mechanism that most email systems use today, we observe the following disadvantages: first, the sender and the receiver have to encode and decode the email, respectively. If the email is short, it does not take much time to do so, but in the case of sending a long email, the operation will take substantial time, consuming computing resources of the computer. At the same time, a long email may demand the resources of the network and the memory capacity. Second, if a sender wants to send the same email to multiple receivers (a situation that happens frequently in mailing list application), the email has to be sent to and stored in multiple servers, thus wasting time and network resources. Further more, since there is a copy of the email in the mailbox of each receiver, we realize that there are multiple copies of the same email existing in the network, thus wasting the memory capacity. On the other hand, since most mailboxes have limited memory capacity, the mailbox is easily flooded by malicious or unwanted emails, preventing friendly emails from being received later.

### BRIEF SUMMARY OF THE INVENTION

For solving the problem mentioned above, it is an objective of the present invention to provide a method for transferring emails by which the email transmission and storage efficiency should be improved, network resources are conserved, and unwanted emails are avoided.

To attain this objective, the method for transferring email according to the present invention comprises sending part and receiving part. Sending email comprises following steps:

(1) a sender x packs an email D into D′ which is to be transmitted to a receiver y;

(2) the sender x transmits the packed email D′ to it's registered mail server X;

(3) the sender x or the server X sets the access permission of D′ on the server X in such a way that D′ on the server X may only be accessed by designated receiver y;

(4) the server X sends a message M to a server Y notifying that an email D′ is accessible to one of its registered user y.

(5) If M is successfully sent, sending operation ends, otherwise, the operation goes to the following step;

(6) if the server X does not receive acknowledgement for M within certain predetermined times N, the operation goes to the step (7). Otherwise goes to step (4), and takes another try.

(7) the server X sends an error report to user x; then ends the session.

Receiving email comprises the steps:

(1) A receiver y receives the message M from a server Y that is registered by its own;

(2) The receiver y downloads the email data D′ packaged by a sender x from a server X based on the message M;

(3) The receiver y unpacks the email data D′ and obtains the email data D.

The message M consists of a memory location that an email resides and the message of the sender.

As described above, it is conceivable that present invention may completely realize the objective of this invention on the basis of:

(1) Transferring an email is based on packing the email, instead of encoding the email. Thus, not only much computing time may be saved, but also the transmission time is saved, since, comparing with encoding, the email data size will not be increased too much out of the packing operation;

(2) According to the method of present invention, emails, both large and short emails are passed not by forwarding the emails itself among servers, but by sending a signaling message to a receiver. Because the signal is short, the efficiency of forwarding emails is greatly improved. If a receiver and a sender are registered on the same server, the email will not be forwarded at all, so that memory capacity and transmission time of network are conserved.

(3) The access permission of the receiver to the sent email is set by the sender or by its registered server in such a way that receiver gets the email directly from the memory area of the sender, and that only emails that are read-enabled can be received. Accordingly, when an email is sent for many times, it is only needed that sender sets an access permission of the receiver to an email on server and sends the email. The duration of the entire process is much shorter than traditional method. Furthermore, because the receiver may directly download an email from the memory area of a sender, if necessary, it is avoided that the identical email is stored redundantly in network. Consequently, the transmission and storage efficiency of an email are improved. Other advantages include saving network resources and ease of use.

(4) As sending an email by a sender is implement by storing the email in its own memory area of its server, it is impossible to occupy the entire mailbox of a receiver by sending a large number of emails. Consequently, such mechanism for transferring email may efficiently prevent the mailbox from being occupied by malicious emails, and thus ensures the security of the email and efficiently transfer the emails.

### BRIEF DESCRIPTION OF THE DRAWINGS

The present invention is further described in conjunction with the appended drawings and an embodiment.

FIG. 1 shows a flow chart of the process for sending an email according to the present invention;

FIG. 2 shows a diagram of the application environment according to the present invention;

FIG. 3 shows a flow chart of the process for receiving an email according to the present invention.

### DETAILED DESCRIPTION OF THE INVENTION

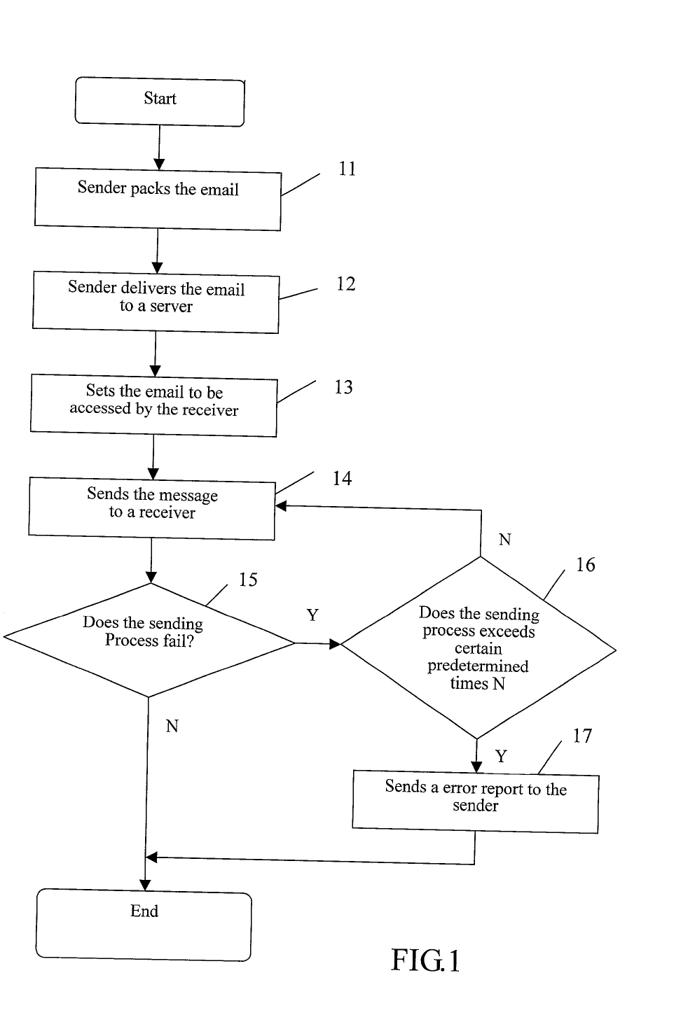

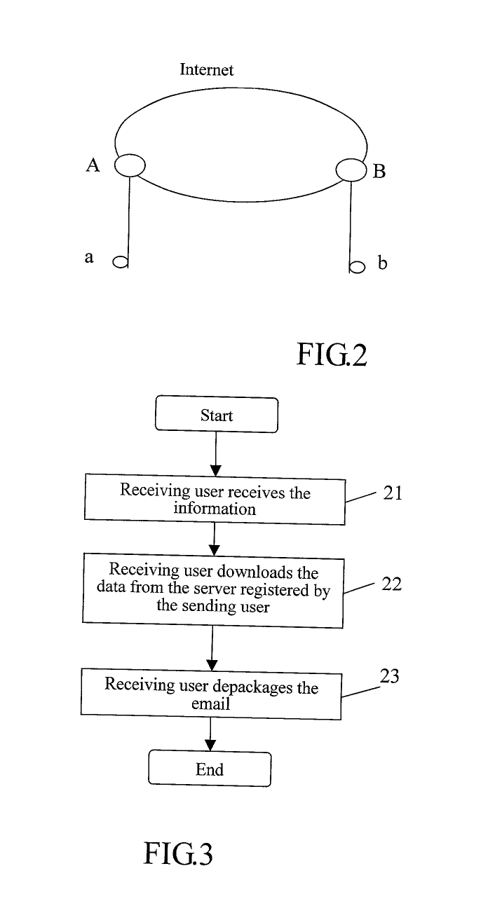

The method for transfer email according to the present invention may be utilized in various networks, such as LAN, Internet and the like. The method of the present invention will be described below with reference to the embodiment for utilizing the method of the present invention in the Internet. It is similar to utilize the method of the present invention in other networks as that in the Internet. Referring to FIG. 2, if there are two servers X and Y in the Internet. Users x and y is registered on servers X and Y respectively. The client software programmed according to the present invention is loaded on users x and y. When user x is intention to transmit an email to user y, the email is transmitted in following steps. Referring to FIG. 1, in step 11, a sender x packages the email data D to be delivered to a receiver y and obtains a packaged email D′. In step 12, the sender x delivers the packed mail data D′ to a server X, which is registered by the sender x. In step 13, the sender x or the server X sets the access permission of the email D′ on the server X in such a way that enables the receiver y to access the email. In step 14, the server X sends the message M indicating that the email data D′ can be accessed by the receiver y to the server Y which is registered by the receiver y. In step 15, it is made for determining whether the message M is successfully delivered. If it is yes, this process ends, otherwise goes to step 16. In step 16, it is made for determining whether or not the times for sending message M exceeds certain predetermined times N. If it is yes, the operation goes to step 17 to continually operate, otherwise goes to above step 14 to continually operate. In step 17, a server X sends an error report to the sender x and ends this operation.

Above certain predetermined times N is obtained by experience, such as 10. Usually, only in the case of not continually successfully sending the email up to N times, it is proved that there is a transmission obstacle on transmission link, and an error report should be sent to the sender x.

The receiver y receives an email by following steps. In step 21, the receiver y receives the message M from the server Y registered by the receiver y. In step 22, the receiver y downloads the packed email data D′from the server X based on the message M. In step 23, the receiver y unpacks the email data D′ to obtain an email data D.

In the process of implementation the method according to the present invention, an email is passed by packing the email data and utilizing the message mechanism, so that the receiver of an email obtains the email from the outbox of the sender, but not from its own mailbox. Thus there is no limitation for the inbox capacity for the receiver in theory, so that the network resources and time for forwarding the email among the servers is saved. Thus the sending of trash email is effectively avoided. Consequently, the method according to the present invention has a practical or immediate significance in actual application. If the method according to the present invention is utilized in the Internet, it is assumed that the application environment is an 8M email storage capacity for each account. At the same time, 10 users may send emails of which each one is 5M to 1 user, and the receiver may get the whole 50M email which is far larger than the storage capacity of the receiver's mailbox. If the email is delivered by using the method of prior art, only one sender may send an email to the recipient, and the other 9 senders may not successfully send an email, as storage capacity of the receiver's mailbox is not enough. Furthermore, if one user sends an identical 5M email to 10 users, only 5M storage capacity of the network server is occupied according to the present invention, and the 50M storage capacity of the network server is occupied by using the conventional method.

Through comparing the method for transfer a 40M email according to the present invention with the conventional method in the environment of P11500, 128M memory and 100M LAN, its results are shown in the table below:

| Present invention | Prior art |
|---|---|
| Packaging time: 40 seconds | Encoding time: 8 minutes |
| Sending time: 1 minute | Sending time: 1 minutes and |
| | 20 seconds |
| Setting time + Sending message time: | |
| <1 seconds | |
| Forwarding message time: <1 second | Forwarding the email: 1 minutes |
| | and 20 seconds |

Viewing this, the coefficient of utilization of the storage capacity may be greatly raised according to the present invention, and it is more scientific in storage management. By delivering an email according to the present invention, the transfer and storage efficiency for an email is greatly improved, saving the network resources at the same time.

Generally, in said method for transferring email, an email is passed through using the message mechanism in the process of delivering the email. Thus the receiver may directly receive the email from the storage area of the sender based on the received message and actual needs, as appropriate. Various modifications or changes may be made by the skilled in the art will not depart from the spirit or scope of the present invention, as the scheme and embodiment of the present invention has described.

[symbol]

FIG. 1

[symbol] : Start

11: Sender packs the email

12: Sender delivers the email to a server

13: Sets the email to be accessed by the receiver

14: Sends the message to a receiver

15: Does the sending process fail?

16: Does the sending process exceeds certain predetermined times N

17: Sends an error report to the sender

[symbol] : End

FIG. 2

Internet [symbol] : Internet

FIG. 3

[symbol] : Start

21: Receiver receives the message

22: Receiver downloads the data from the server designated by the sender

23: Receiver unpacks the email

[symbol] : End

1. A method for email communication with the following characteristics.
Steps involved at sender side:
(1) a sender x packs an email D into D′ which is to be transmitted to a receiver y;
(2) the sender x transmits the packed email D′ to it's registered mail server X;
(3) the sender x or the server X sets the access permission of D′ on the server X in such a way that D′ on the server X may only be accessed by designated receiver y;
(4) the server X sends a message M to a server Y notifying that an email D′ is accessible to one of its registered user y.
(5) If M is successfully sent, sending operation ends, otherwise, the operation goes to the following step;
(6) if the server X does not receive acknowledgement for M within certain predetermined times N, the operation goes to the step (7). Otherwise goes to step (4), and takes another try.
(7) the server X sends an error report to user x; then ends the session.
Steps involved at receiver side:
(1) a receiver y receives a message M from it's mail server Y
(2) the receiver y downloads a packed email D′ from server X based on the message in M;
(3) the receiver y unpacks D′ and reveals the original email data D.

2. Following the above item 1, according to method that generates message M which consists of the location that stores the email and the message of the sender.
